(19) United States
(12) Patent Application Publication
(10) Pub. No.: US 2008/0069478 A1
(43) Pub. Date: Mar. 20, 2008

(54) APPARATUS, METHOD, AND COMPUTER PROGRAM PRODUCT FOR DISPLAYING IMAGE

(75) Inventors: Kazuyasu Ohwaki, Kanagawa (JP); Masahiro Baba, Kanagawa (JP); Goh Itoh, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/853,079

(22) Filed: Sep. 11, 2007

(30) Foreign Application Priority Data
Sep. 20, 2006 (JP) 2006-254507

(51) Int. Cl. G06K 9/32

(52) U.S. Cl. 382/300

(57) ABSTRACT

An apparatus includes an interpolation image generating unit that generates an interpolation image between frames of an input image, from the input image, an evaluating unit that evaluates image accuracy of the interpolation image, a luminance ratio setting unit that sets luminance ratios of the input image and the interpolation image in such a manner that luminance of the interpolation image decreases as the image accuracy decreases, a luminance converting unit that generates a converted input image and a converted interpolation image by converting luminance of the input image and the luminance of the interpolation image respectively in accordance with the luminance ratio, and a display unit that displays one of the converted input image and the converted interpolation image in a first half of one frame period of the input image, and displaying other image thereof in a second half.

### CROSS-REFERENCE TO RELATED APPLICATIONS

This application is based upon and claims the benefit of priority from Japanese Patent Application No. 2006-254507, filed Sep. 20, 2006, the entire contents of which are incorporated herein by reference.

### BACKGROUND OF THE INVENTION

1. Field of the Invention

The present invention relates to an apparatus, method, and computer program product for displaying motion pictures.

2. Description of the Related Art

Generally, image display apparatuses include impulse-type image display apparatuses and hold-type image display apparatuses. The impulse-type image display apparatuses continue to emit light only within persistence time of phosphors after an image has been written. The hold-type image display apparatuses keep displaying the previous frame until a new image is written. Examples of the impulse-type image display apparatus are Cathode Ray Tube (CRT) display and field emission type display (FED). Examples of the hold-type image display apparatuses are liquid crystal display devices (LCD) and an electro luminescent display (ELD).

A problem in the hold-type image display apparatuses is occurrence of motion blur. The motion blur occurs because a plurality of frames overlap so as to be projected onto the retina, when the plurality of frames includes moving objects and the viewer's eyes follow the movement of the moving objects.

The same previous frame remains to be displayed until the previous frame of the display image is switched to the next frame thereof. However, viewer's eyes move along the movement direction of the moving objects on the previous frame image, under the estimation of the display of the next frame image. Due to a finer sampling than the frame interval, the eyes visibly recognize the image as being embedded between the adjacent two frames, thereby observing the image as motion blur.

For example, a patent document JP-A 11-109921 (KOKAI) discloses a method for displaying “black” using a certain means after displaying the frame(s), in order to overcome the above-described problem in the display apparatus performing the hold-type display. Another patent document JP-A 2002-123223 (KOKAI) discloses a method for displaying “black” between continuous frames, when an input image is a motion picture based on a determination of whether the input image is a motion picture or a still picture. Still another patent document JP-A 2005-6275 (KOKAI) discloses a method for overcoming the above-described problem by generating and inserting an interpolation image between frames, and increasing the frame rate.

A problem is that the display screen becomes dark when displaying the black image as described above. The power consumption for backlight will be wasted if the backlight remains to be on even during the black display period. A problem in the still pictures is that flickers occur due to impulse type display. When an interpolation image is inserted between frames, an inappropriate interpolation image may be inserted, thus resulting in image deterioration.

### SUMMARY OF THE INVENTION

According to one aspect of the present invention, an apparatus includes an interpolation image generating unit that generates an interpolation image between frames of an input image, from the input image; an evaluating unit that evaluates image accuracy of the interpolation image, a luminance ratio setting unit that sets luminance ratios of the input image and the interpolation image in such a manner that luminance of the interpolation image decreases as the image accuracy decreases, a luminance converting unit that generates a converted input image and a converted interpolation image by converting luminance of the input image and the luminance of the interpolation image respectively in accordance with the luminance ratio, and a display unit that displays one of the converted input image and the converted interpolation image in a first half of one frame period of the input image, and displaying other image thereof in a second half.

According to another aspect of the present invention, an apparatus includes an interpolation image generating unit that generates an interpolation image between frames of an input image, from the input image, an accuracy evaluating unit that evaluates image accuracy of the interpolation image, a luminance ratio setting unit that sets luminance ratios of the input image and the interpolation image, in such a manner that the interpolation image becomes darker as the image accuracy decreases, an output unit that outputs the input image and the interpolation image on a liquid crystal panel in one frame period, a surface light source that is arranged at back of the liquid crystal panel and serves as lighting of the liquid crystal panel, and a surface light source control unit that controls output of the surface light source, in accordance with the luminance ratio set by the luminance ratio setting unit.

According to still another aspect of the present invention, an image display method includes generating an interpolation image between frames of an input image, from the input image, evaluating image accuracy of the interpolation image, setting luminance ratios of the input image and the interpolation image in such a manner that luminance of the interpolation image decreases as the image accuracy decreases, generating a converted input image and a converted interpolation image by converting luminance of the input image and the luminance of the interpolation image respectively in accordance with the luminance ratio, and displaying one of the converted input image and the converted interpolation image in a first half of one frame period of the input image, and displaying other image thereof in a second half.

According to still another aspect of the present invention, an image display method includes generating an interpolation image between frames of an input image, from the input image, determining image accuracy of the interpolation image, setting luminance ratios of the input image and the interpolation image in such a manner that the interpolation image becomes darker as the image accuracy decreases, based on the image accuracy, outputting the input image and the interpolation image on a liquid crystal panel for one frame period, and controlling output of a surface light source which is arranged at back of the liquid crystal panel and serves as lighting of the liquid crystal panel, in accordance with the set luminance ratios.

According to still another aspect of the present invention, a computer program product has a computer readable medium including programmed instructions, wherein the instructions, when executed by a computer, cause the computer to perform: generating an interpolation image between frames of an input image, from the input image; evaluating image accuracy of the interpolation image; setting luminance ratios of the input image and the interpolation image in such a manner that luminance of the interpolation image decreases as the image accuracy decreases; generating a converted input image and a converted interpolation image by converting luminance of the input image and the luminance of the interpolation image respectively in accordance with the luminance ratio; and displaying one of the converted input image and the converted interpolation image in a first half of one frame period of the input image, and displaying other image thereof in a second half.

According to still another aspect of the present invention, a computer program product has a computer readable medium including programmed instructions, wherein the instructions, when executed by a computer, cause the computer to perform: generating an interpolation image between frames of an input image, from the input image; determining image accuracy of the interpolation image; setting luminance ratios of the input image and the interpolation image in such a manner that the interpolation image becomes darker as the image accuracy decreases, based on the image accuracy; outputting the input image and the interpolation image on a liquid crystal panel for one frame period; and controlling output of a surface light source which is arranged at back of the liquid crystal panel and serves as lighting of the liquid crystal panel, in accordance with the set luminance ratios.

### BRIEF DESCRIPTION OF THE DRAWINGS

FIG. 1 is a diagram showing an overall configuration of an image display apparatus according to Embodiment 1;

FIG. 2 is a diagram for explaining an interpolation image;

FIG. 3 is a diagram for explaining a block matching process;

FIG. 4 is a diagram for explaining a first modification of the block matching;

FIG. 5 is a diagram for explaining a second modification of the block matching;

FIG. 6 is a diagram for explaining a first modification of an accuracy discriminating process for an interpolation image;

FIG. 7 is a diagram for explaining a second modification of the accuracy discriminating process for an interpolation image;

FIG. 8 is a diagram for explaining a third modification of the accuracy discriminating process for an interpolation image;

FIG. 9 is a diagram showing the relationship between accuracy and luminance ratio;

FIG. 10 is a diagram showing the relationship between the accuracy set between 25% and 50% and the luminance ratio;

FIG. 11 is a flowchart showing an image display process by the image display apparatus according to Embodiment 1;

FIG. 12 is a diagram showing the hardware configuration of the image display apparatus according to Embodiment 1;

FIG. 13 is a diagram showing an overall configuration of an image display apparatus according to Embodiment 2;

FIGS. 14A and 14B are diagrams for explaining a process of a luminance ratio determining unit;

FIGS. 15A and 15B are diagrams for explaining a process of the luminance ratio determining unit;

FIG. 16 is a flowchart showing in detail a particular process of a luminance ratio determining process by the image display apparatus according to Embodiment 2;

FIG. 17 is a block diagram showing an overall configuration of an image display apparatus according to Embodiment 3;

FIG. 18 is a diagram for explaining backlight control by a backlight control unit;

FIG. 19 is a flowchart showing an image display process by the image display apparatus according to Embodiment 3;

FIG. 20 is a diagram showing an overall configuration of an image display apparatus according to Embodiment 4;

FIG. 21 is a diagram for explaining backlight control by the backlight control unit; and

FIG. 22 is a flowchart showing an image display process by an image display apparatus according to Embodiment 4.

### DETAILED DESCRIPTION OF THE INVENTION

Embodiments of an image display apparatus, image display method, and image display computer program product according to the present invention will now specifically be described with reference to the drawings. The description of the preferred embodiments is not to limit the present invention.

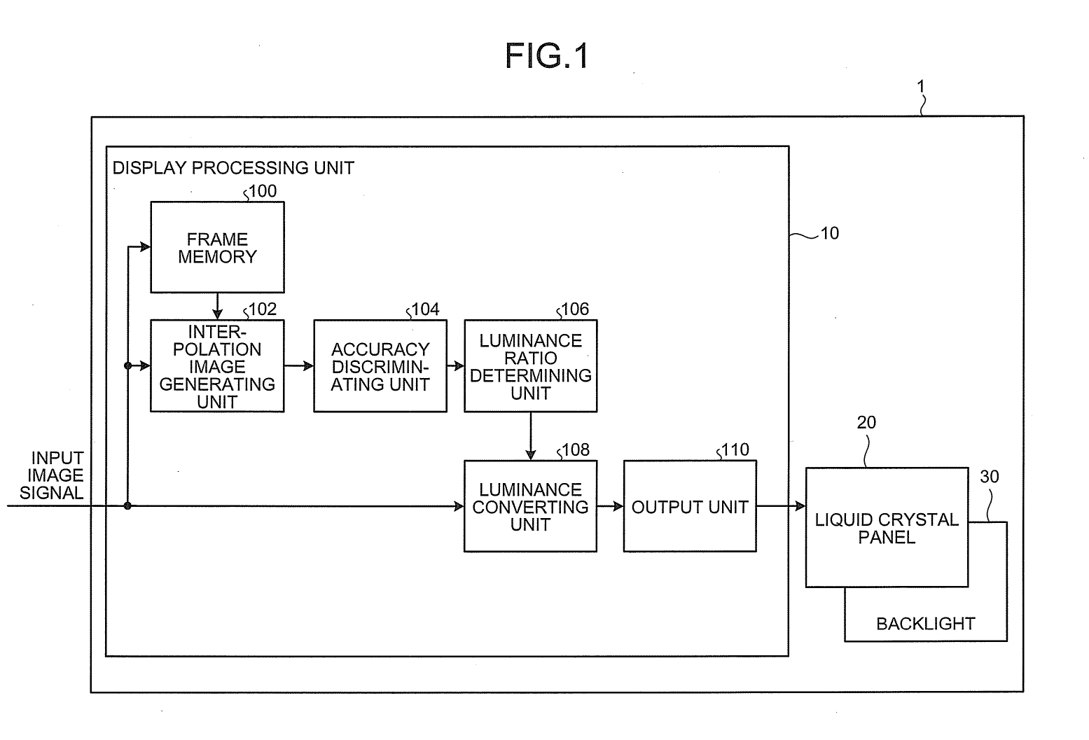

As shown in FIG. 1, an image display apparatus 1 includes a display processing unit 10 processing an input image signal, a liquid crystal panel 20 displaying an image processed by the image processing unit 10, and a backlight 30 as a surface light source which is arranged at the back of the liquid crystal panel 20 so as to irradiate the liquid crystal panel 20 therefrom.

The display processing unit 10 has a frame memory 100, an interpolation image generating unit 102, an accuracy discriminating unit 104, a luminance ratio determining unit 106, a luminance converting unit 108, and an output unit 110. The frame memory 100 externally acquires an input image signal, and keeps one frame of the input image signal for one frame period. The one frame period is a time period since a predetermined frame is displayed until the next frame is displayed on the liquid crystal panel 20. After the one frame period has elapsed, the frame memory 100 outputs this frame to the interpolation image generating unit 102.

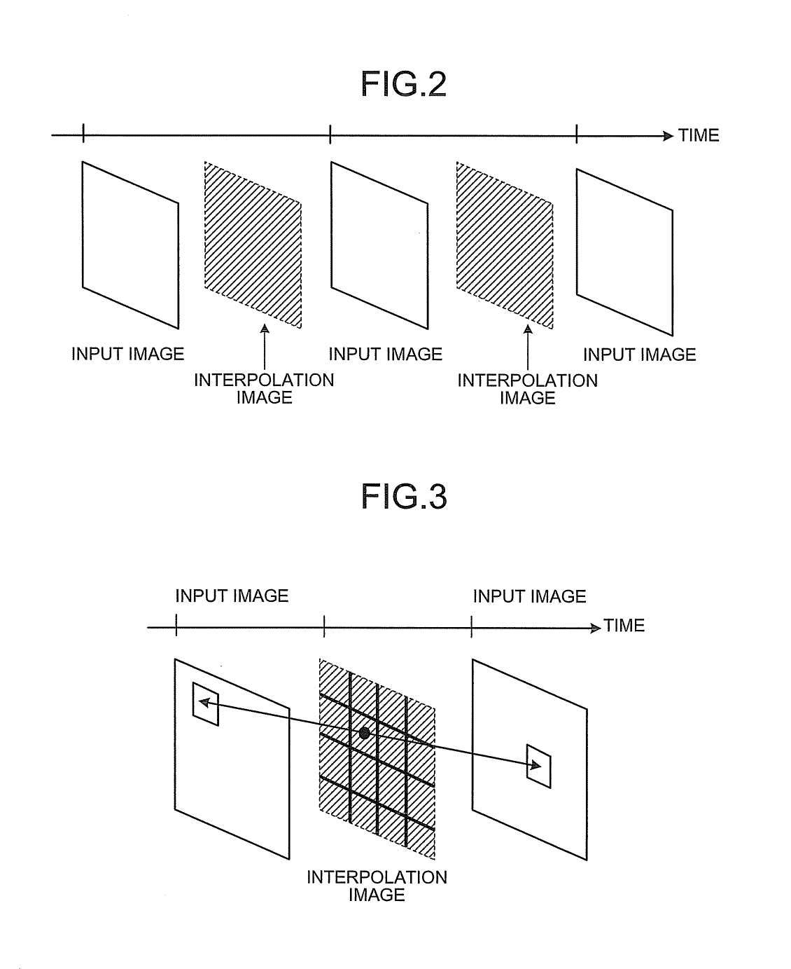

The interpolation image generating unit 102 externally acquires an input image signal. Further, the interpolation image generating unit 102 acquires one-frame delayed image signal from the frame memory 100, and generates an interpolation image based on the input image signal and the delayed image signal. As shown in FIG. 2, the interpolation image is an image to be interpolated between the input images.

The interpolation image generating unit 102 detects a motion vector by performing block-matching of the adjacent two input images, and generates an interpolation image based on the motion vector. As shown in FIG. 3, the interpolation frame is divided into blocks. Similar blocks on a line segment connecting the two input images are searched with reference to an area (as a fulcrum) in each block of the interpolation frame.

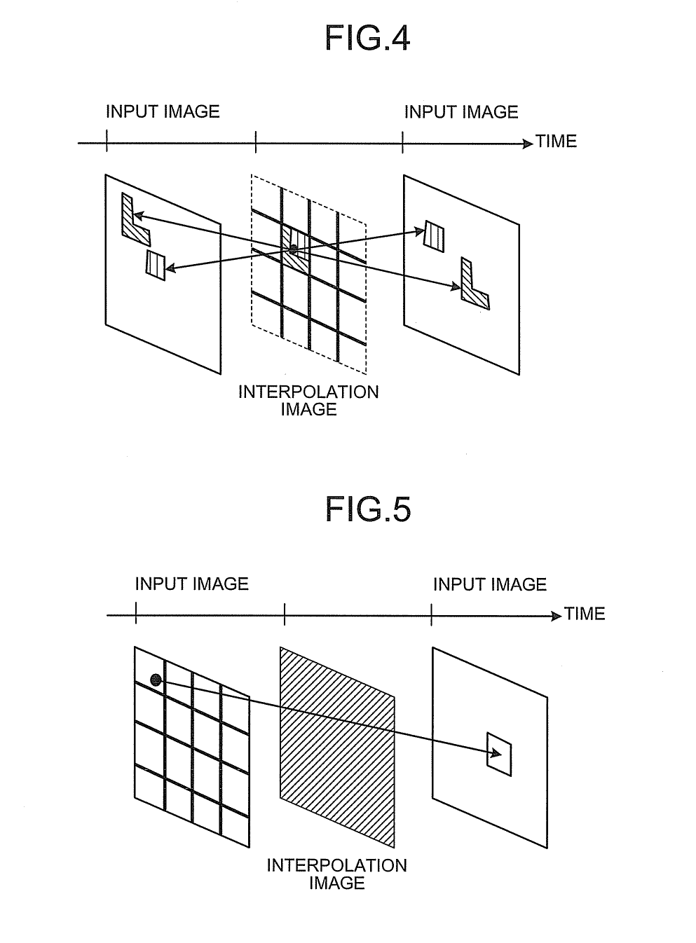

Alternatively, as shown in FIG. 4, each block of the interpolation frame may be divided into areas of objects. Similar blocks on a line segment connecting the two input images may be searched with reference to an area (as a fulcrum) in each area of the interpolation frame.

Still alternatively, as shown in FIG. 5, one input image may be divided into blocks so as to search blocks of the other input image, respectively.

The interpolation image generation is not limited to continuous two frames in time, but a plurality of frames may be referred to, for example. When the input signal is an interlace image signal, motion detection may be performed using only fields of even numbers or fields of odd numbers.

The motion detection process is not limited to motion vector calculation by the block matching, but any other motion detection process may be performed.

When motion vector information can be acquired, for example when an input image includes motion vector information, such as MPEG2, etc., an interpolation image may be generated based on this motion vector information.

The description will now be returned to FIG. 1. The accuracy discriminating unit 104 discriminates the accuracy of the interpolation image created by the interpolation image generating unit 102. The accuracy, in this case, is a value indicating the sureness that the image represents the correct contents of an image between the two input images. For example, the accuracy discriminating unit 104 discriminates that accuracy of an image is low, if the motion compensation estimation residual is large when the interpolation image is created.

Specifically, the accuracy discriminating unit 104 calculates the absolute difference of the luminance of corresponding pixels of the two input images used for the motion vector detection, in accordance with the motion vector detected at the time of interpolation image generation, for each pixel on the interpolation frame. Then, the accuracy discriminating unit 104 calculates the sum of the difference values for the all pixels of the interpolation frame. The larger the sum is, the lower the accuracy of the interpolation image is.

According to a first modification of the accuracy discriminating process for the interpolation image, it may be discriminated that the accuracy is low, if the motion compensation estimation residual is large in a predetermined area when the interpolation image is created. Specifically, the interpolation image is divided into a plurality of blocks. The sum of the absolute differences of the luminance in each block is obtained. When there is a region having a remarkably large sum of the absolute differences, it is discriminated that the accuracy is lower than the image which does not include such an area. The accuracy may be discriminated to be lower when the areas with a large sum of the absolute differences are more concentrated in some region of the interpolation image.

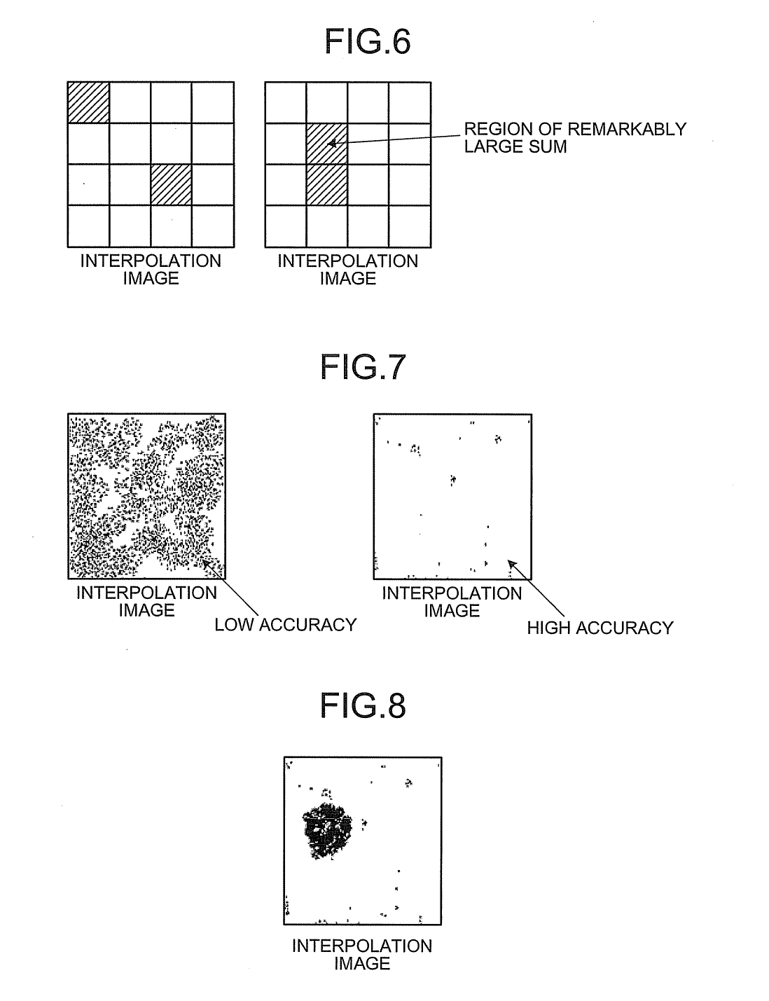

In the interpolation image shown in FIG. 6, those blocks having a remarkably large sum of the absolute differences are shown by oblique hatching. Both of the two interpolation images of FIG. 6 have two blocks having a large sum of the absolute differences. The interpolation image on the right has the blocks that are more concentrated in some region than the blocks of the interpolation image on the left. In this case, it may be discriminated that the accuracy of the interpolation image on the right is lower than that of the interpolation image on the left.

According to a second modification of the accuracy discriminating process for the interpolation image, it may be discriminated that the accuracy of the interpolation image is low, if the number of pixels whose motion compensation estimation residual is equal to or lower than a predetermined threshold value is large when the interpolation image is created. Specifically, the accuracy discriminating unit 104 calculates the absolute differences of the luminance of the corresponding pixels of the two input images used for the motion vector detection. Then, the accuracy discriminating unit 104 counts the number of pixels whose absolute differences are equal to or lower than a set threshold value. The larger the counted number of pixels, the lower the accuracy.

In FIG. 7, black spots in the interpolation images represent the pixels whose absolute differences are equal to or lower than the threshold value. In the example of FIG. 7, the interpolation image on the left includes more pixels whose absolute differences are equal to or lower than the threshold value, compared to the interpolation image on the right. Thus, the accuracy of the interpolation image on the left is lower than that of the interpolation image on the right.

According to a third modification of the accuracy discriminating process for the interpolation image, it may be discriminated that the accuracy of the interpolation image is low, as regions with the pixels whose motion compensation estimation residuals are equal to or lower than a predetermined threshold value are concentrated in a predetermined region, when the interpolation image is created. Specifically, it is discriminated that the accuracy is low, as the pixels whose absolute differences are equal to or lower than the threshold value are concentrated.

In FIG. 8, black spots in the interpolation image represent the pixels whose absolute differences are equal to or lower than the threshold value. In the interpolation image of FIG. 8, the pixels whose absolute differences are equal to or lower than the threshold value are concentrated in the center left position. When the pixels whose absolute differences are equal to or lower than the threshold value are concentrated in some region as in FIG. 8, the accuracy is low, as compared to the interpolation image including the same number of evenly existing pixels. In this embodiment, the absolute differences are referred to for discriminating the accuracy. However, the squared sum of the difference may be used instead. The motion vector or information about the input image(s) may be referred to for discriminating the accuracy.

The description will now be returned to FIG. 1. The luminance ratio determining unit 106 determines the luminance ratios of the input image and interpolation image that are displayed in one frame period on the liquid crystal panel 20, based on the accuracy determined by the accuracy discriminating unit 104. The higher the accuracy of the interpolation image discriminated by the accuracy discriminating unit 104, the higher the luminance ratio of the interpolation image.

When the accuracy is the maximum, the luminance ratios of the input image and interpolation image are set at 50%. That is, the luminance ratio of the input image and the interpolation image is 1:1. When the accuracy is the minimum, the luminance ratio is set at 0%. For example, when the luminance ratio is 0%, the interpolation image is a black image. The luminance ratio of the input image is so determined in accordance with the luminance ratio of the interpolation image that the sum of the luminance ratio of the input image and the luminance ratio of the interpolation image will be 100%.

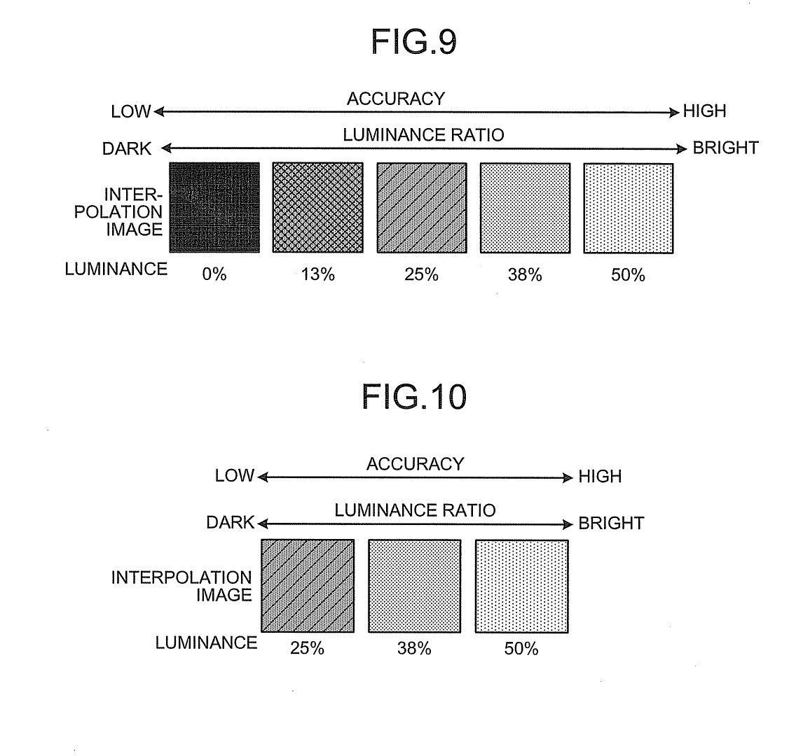

The luminance ratio of the interpolation image is set at five scales from 0% to 50%, as shown in FIG. 9. The accuracy of the image corresponds to any of the five scales of the luminance ratio. The luminance ratio determining unit 106 keeps correspondence information representing the relationship between the accuracy and luminance ratio shown in FIG. 9. The luminance ratio determining unit 106 determines the luminance ratio corresponding to the accuracy acquired from the accuracy discriminating unit 104, based on this correspondence information.

In this embodiment, the luminance ratio of the interpolation image is set between 0% and 50%. However, according to another example, the luminance ratio may be set, for example, between 25% and 50%. FIG. 10 is a diagram showing the relationship between the accuracy and the luminance ratio in this case. By setting a high luminance value for the interpolation image when the accuracy of the interpolation image is the minimum, the image brightness in combination of the input image and the interpolation image can even be brighter.

The relationship between the accuracy and luminance ratio of the interpolation image can be linear or nonlinear. The level of the interpolation accuracy and the luminance of the interpolation image may be set at any scales.

The description will now be returned to FIG. 1. The luminance converting unit 108 converts the luminance of the input image and the interpolation image, using the luminance ratio determined by the luminance ratio determining unit 106. The output unit 110 displays the input image and the interpolation image whose luminance values has been converted by the luminance converting unit 108, on the liquid crystal panel 20 for one frame period.

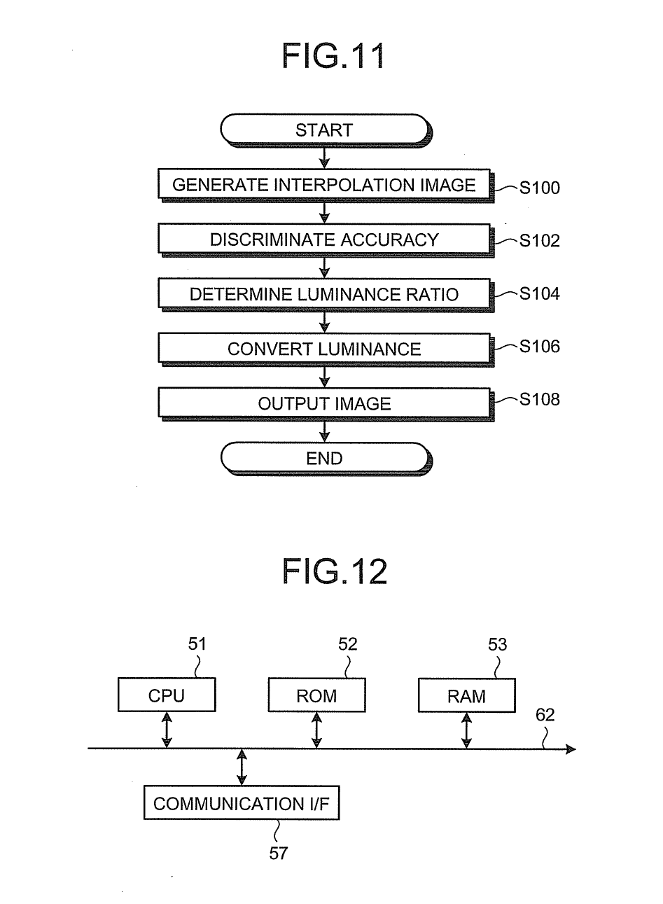

As shown in FIG. 11, in an image display process by the image display apparatus 1 according to Embodiment 1, the interpolation image generating unit 102 generates an interpolation image, based on an input image acquired externally and from the frame memory 100 (Step S100). The accuracy discriminating unit 104 discriminates the accuracy of the interpolation image generated by the interpolation image generating unit 102 (Step S102). The luminance ratio determining unit 106 determines the luminance ratios of the input image and interpolation image, based on the accuracy discriminated by the accuracy discriminating unit 104 (Step S104). The luminance converting unit 108 converts the luminance of the input image and interpolation image, using the luminance ratio determined by the luminance ratio determining unit 106 (Step S106). The output unit 110 outputs the luminance-converted input image and the luminance-converted interpolation image onto the liquid crystal panel 20 for one frame period (Step S108). The image display apparatus 1 thus completes the image display process.

In this manner, the image quality can be improved by adding the interpolation image. Further, when the accuracy of the interpolation image is low, the image quality can be improved by lowering the luminance.

As shown in FIG. 12, the image display apparatus 1 has the hardware configuration including a ROM 52, a CPU 51, a RAM 53, a communication I/F 57, and a bus 62 connecting each of the units. The ROM 52 stores an image display program(s) for executing the image display process in the display processing unit 10. The CPU 51 controls each unit of the display processing unit 10 in accordance with the program of the ROM 52. The RAM 53 stores various data necessary for controlling the image display apparatus 1. The communication I/F 57 is connected to a network so as to perform communications.

The above-described image display program may be stored in and provided from a computer readable recording medium, such as CD-ROM, floppy (registered trademark) disk (FD), DVD, etc. in a file format that can be installed or executed.

In this case, the image display program is read from the recording medium and executed in the image display apparatus 1 so as to be loaded into a main memory unit. Each unit, described in the software configuration, is generated on the main memory unit.

The image display program according to this embodiment may be stored in a computer connected to a network, such as the Internet, and downloaded and provided through the network.

The embodiment of the present invention has thus been described. Various changes or improvement can be made to the embodiment.

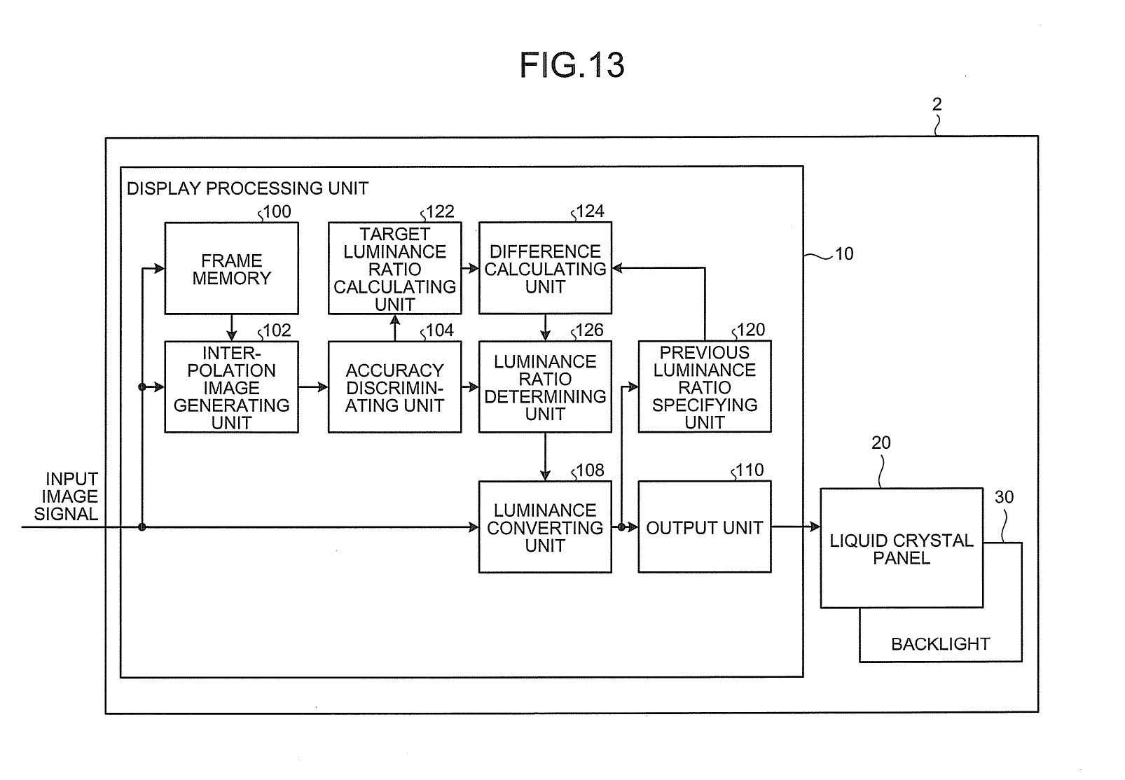

As illustrated in FIG. 13, in place of the luminance ratio determining unit 106, the display processing unit 10 included in an image display apparatus 2 according to Embodiment 2 includes a previous luminance ratio specifying unit 120, a target luminance ratio calculating unit 122, a difference calculating unit 124, and a luminance ratio determining unit 126.

The previous luminance ratio specifying unit 120 specifies the luminance ratio of an interpolation image previous to the interpolation image whose luminance is to be converted, that is the previous luminance ratio. The target luminance ratio calculating unit 122 calculates the target luminance ratio, based on a result of discrimination by the accuracy discriminating unit 104. The target luminance ratio corresponds to the luminance ratio which is determined by the luminance ratio determining unit 106 in Embodiment 1.

The difference calculating unit 124 calculates a difference between the target luminance ratio calculated by the target luminance ratio calculating unit 122 and the previous luminance ratio specified by the previous luminance ratio specifying unit 120. The luminance ratio determining unit 126 determines a value that has been obtained by varying the previous luminance ratio by a predetermined variation amount, as a luminance ratio, when the difference calculated by the difference obtaining unit 124 is equal to or greater than a predetermined threshold value.

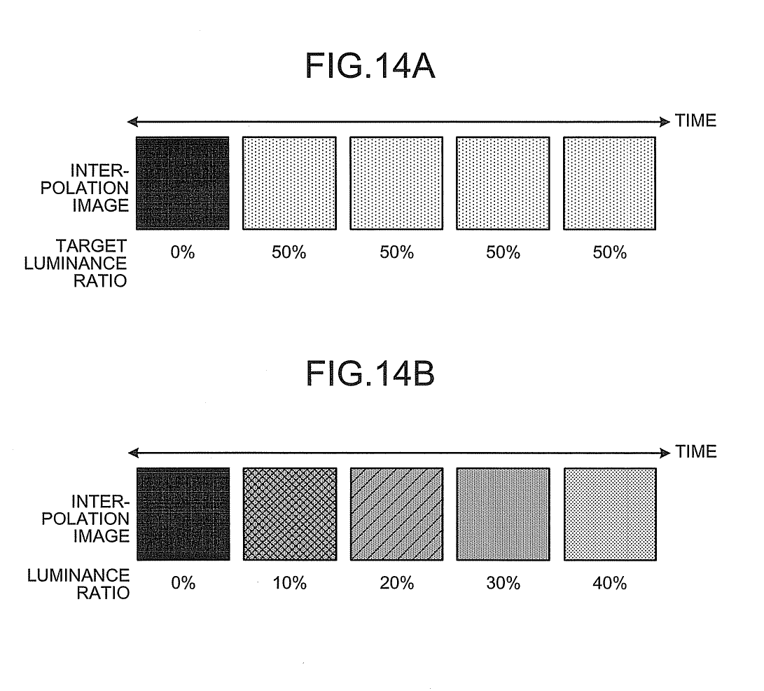

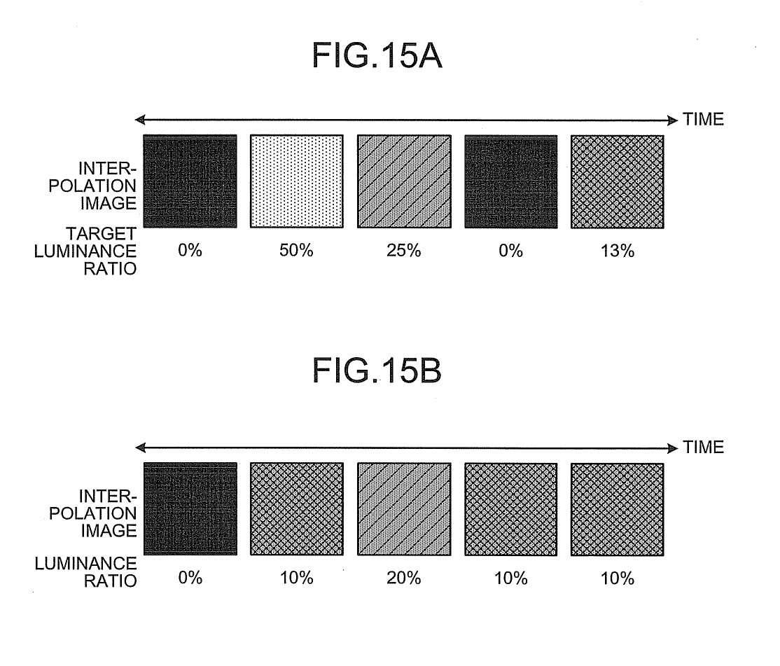

FIG. 14A, FIG. 14B, FIG. 15A, and FIG. 15B are diagrams for explaining the process by the luminance ratio determining unit 126. It is assumed that the threshold value set in the luminance ratio determining unit 126 is 10%, while the maximum variation amount is set at 10%. It is also assumed that the target luminance ratio calculating unit 122 obtains the target luminance ratios shown in FIG. 14A. Because the previous luminance ratio is 0% and the next target luminance ratio is 50%, the difference is 50%. That is, the difference is greater than 10%. In this case, the luminance ratio determining unit 126 sets the variation amount at 10%, and determines the luminance ratio of 10% which is 10% greater than the previous luminance ratio. As a result of this process, even if the sequentially calculated target luminance ratios are 0%, 50%, 50%, 50%, and 50% as shown in FIG. 14A, the luminance ratios can be varied by 10%, as shown in FIG. 14B.

Next, assume that the target luminance ratios shown in FIG. 15A are obtained. In this case, the luminance ratio determining unit 126 determines the luminance ratio of each interpolation image, on the assumption that the maximum variation amount is 10% similarly to the above.

Thus, even if the target luminance is remarkably varied, and the variation exceeds a threshold value, the variation range can be suppressed to the variation amount at most, whereby image deterioration resulting from the large variation of the luminance can be suppressed.

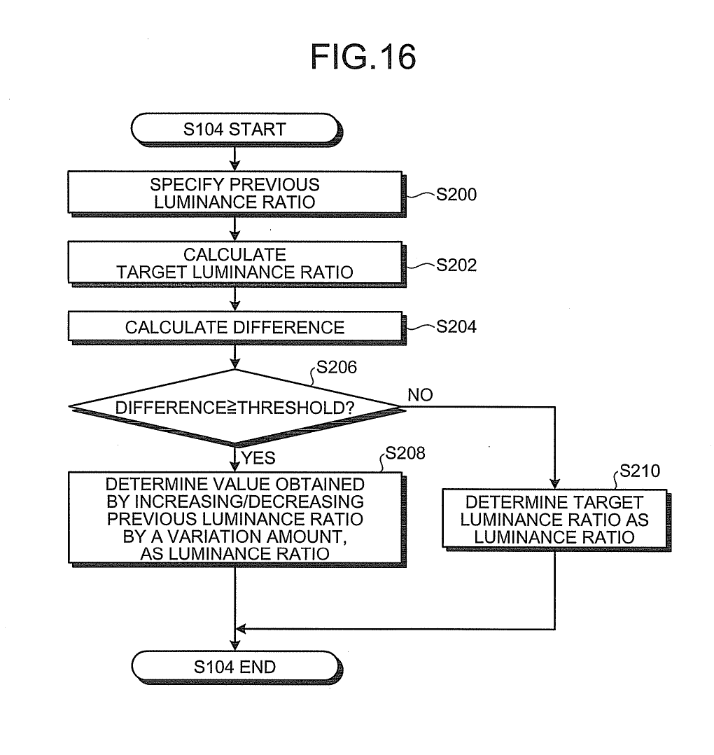

As illustrated in FIG. 16, in a luminance ratio determining process (Step S104) by the image display apparatus 2 according to Embodiment 2, the previous luminance ratio specifying unit 120 specifies the previous luminance ratio (Step S200). Further, the target luminance ratio calculating unit 122 calculates the target luminance ratio based on a result of discrimination by the accuracy discriminating unit 104 (Step S202). The procedures of Step S200 and Step S202 may be executed in the reverse order or may be executed at the same time.

The difference calculating unit 124 calculates a difference between the target luminance ratio and the previous luminance ratio (Step S204). When the difference is equal to or greater than a threshold value (Step S206, Yes), the luminance ratio determining unit 126 determines a value that is obtained by increasing/decreasing the previous luminance ratio by a variation amount, as a luminance ratio (Step S208). When the difference is lower than the threshold value (Step S206, No), the luminance ratio determining unit 126 determines the target luminance ratio as a luminance ratio (Step S210). The luminance ratio determining process (Step S104) is thus completed.

Any other configuration and processing of the image display apparatus 2 according to Embodiment 2 are the same as those of the image display apparatus 1 according to Embodiment 1.

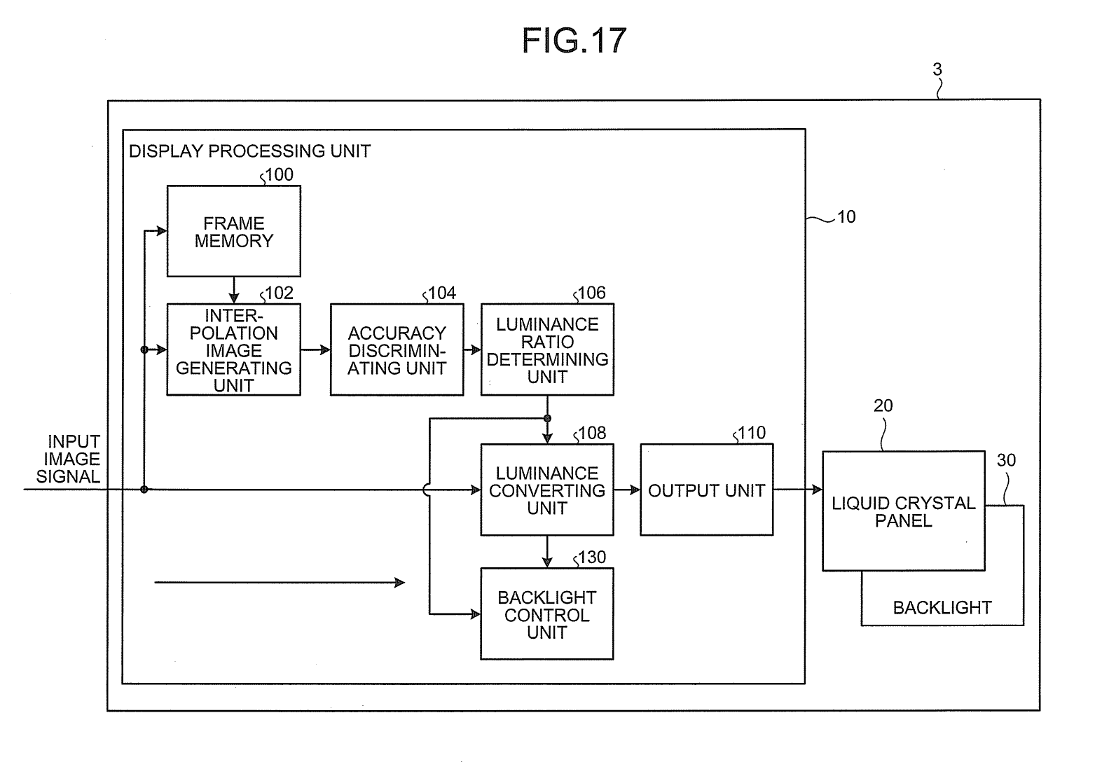

As shown in FIG. 17, the display processing unit 10 provided in an image display apparatus 3 according to Embodiment 3 includes a backlight control unit 130, in addition to the functional configuration of the image display apparatus 1 according to Embodiment 1. The backlight control unit 130 determines the luminance of the backlight and outputs as a luminance signal to the backlight 30, based on the luminance ratio determined by the luminance ratio determining unit 106.

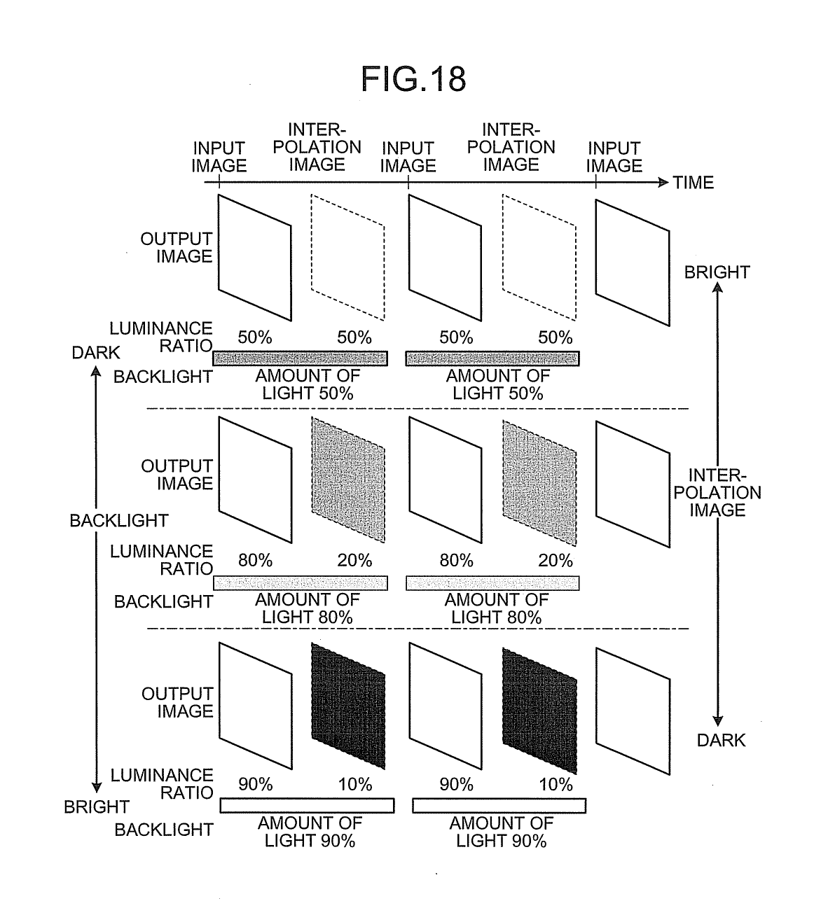

As illustrated in FIG. 18, the backlight control unit 130 so controls the backlight that its luminance is always constant for one frame period. Further, the backlight control unit 130 controls the luminance of the backlight 30 so as to have a constant ratio of the total luminance for one frame period when displaying the input image and the interpolation image in one frame period to the total luminance for one frame period when displaying the input image in one frame period with a predetermined level of backlight luminance. That is, the backlight control unit 130 controls the backlight 30 such that the luminance of the backlight 30 decreases as the interpolation image becomes brighter.

Specifically, the luminance (Bcurr) of the backlight 30 is determined by Equation 1:
Bcurr=Bmax/(1+Int) (Equation 1).

Here, Bmax represents the maximum luminance of the backlight 30, when the interpolation image is to be inserted. In addition, Int represents a relative value of the luminance ratio of the interpolation image, when the luminance ratio of the input image is set at 1.

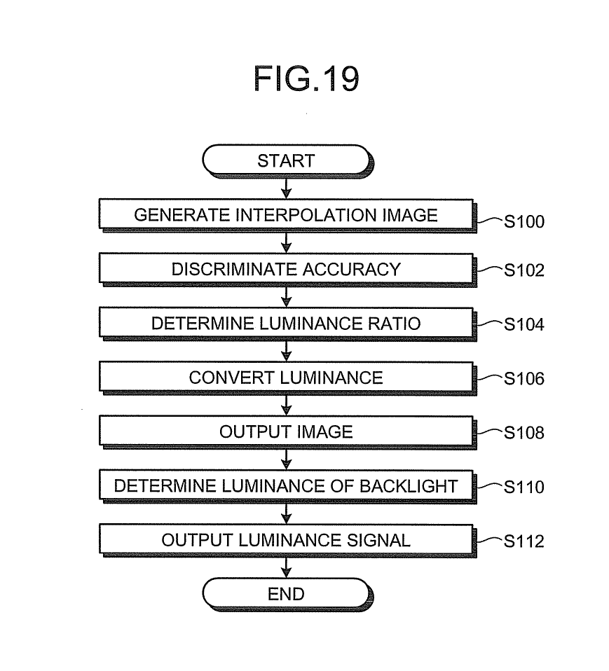

As shown in FIG. 19, when the luminance ratio is determined (Step S104) in the image display process by the image display apparatus 3 according to Embodiment 3, the backlight control unit 130 determines the luminance of the backlight 30 in accordance with the luminance ratio determined by the luminance ratio determining unit 106 (Step S110), and outputs a luminance signal representing the determined luminance value to the backlight 30 (Step S112). The backlight control unit 130 controls the output timing in such a manner that the images output in Step S108 are irradiated by the backlight 30 in accordance with the luminance signal output in Step S112. The procedures of Step S106 and Step S110 may be executed in the reverse order or may be executed at the same time.

As described above, the luminance value of the interpolation image is converted in accordance with the accuracy of the interpolation image, and the output value of the backlight is controlled. As a result, smooth motion pictures can be displayed with fewer flickers and less motion blur, when the accuracy of the interpolation image is high. Further, even when the accuracy of the interpolation image is low, the image deterioration of the interpolation image cannot easily be noticed while the features of the smooth motion pictures with fewer flickers and less motion blur are maintained. As a result, the quality of motion pictures can be improved.

The luminance of the backlight can be suppressed, as the accuracy in generating the interpolation image is higher in motion pictures as well as in still pictures (which have high interpolation accuracy). Thus, the power consumption for the backlight can be reduced, as compared to the black display or the case where discrimination between a still picture and motion picture is performed.

Any other configuration and processing of the image display apparatus 3 according to Embodiment 3 are the same as those of the image display apparatuses according to other embodiments.

According to a first modification of Embodiment 3, the luminance variation may be suppressed to a predetermined range centered around a standard luminance, within one frame period. The luminance variation may be suppressed to such a range that the variation of the luminance cannot visibly be noticed.

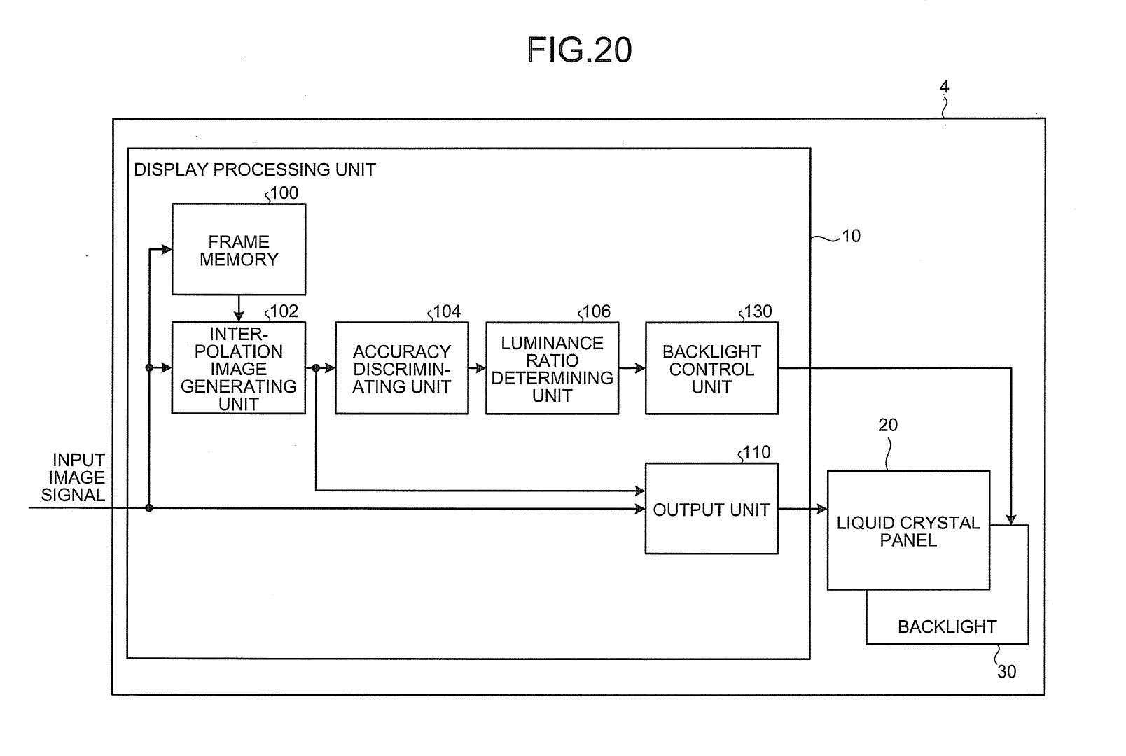

As illustrated in FIG. 20, an image display apparatus 4 according to Embodiment 4 does not convert the luminance of images, but only controls the output of the backlight 30. The image display apparatus 4 according to Embodiment 4 includes a frame memory 100, an interpolation image generating unit 102, an accuracy discriminating unit 104, a luminance ratio determining unit 106, an output unit 110, and a backlight control unit 130.

The output unit 110 outputs the input image and the interpolation image generated by the interpolation image generating unit 102 to the liquid crystal panel 20 for one frame period. The backlight control unit 130 controls the output of the backlight, based on the luminance ratio determined by the luminance ratio determining unit 106.

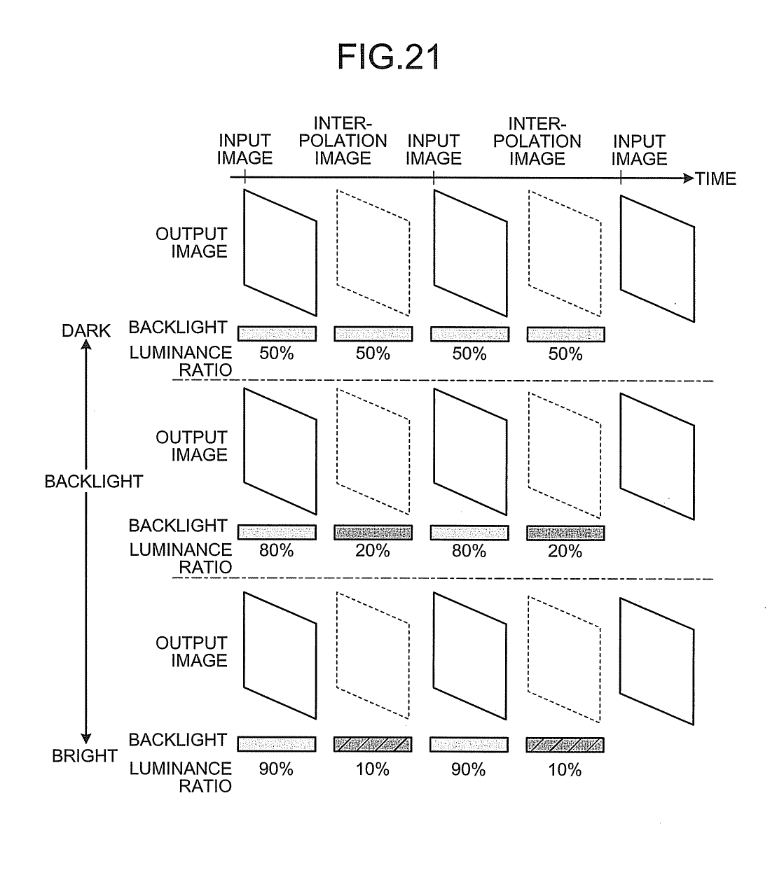

As illustrated in FIG. 21, the backlight control unit 130 controls the backlight at a timing the image is switched. That is, the output of the backlight is switched at a timing the input image is displayed or the interpolation image is displayed. The backlight control unit 130 increases the luminance of the backlight, as the luminance ratio of the interpolation image which is determined by the luminance ratio determining unit 106 increases.

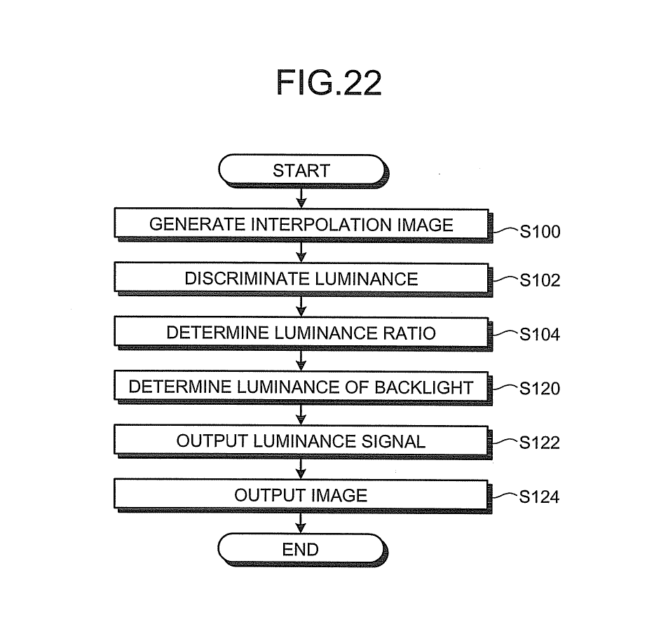

As illustrated in FIG. 22, in the image display process by the image display apparatus 4 according to Embodiment 4, when the luminance ratio determining unit 106 determines the luminance ratio (Step S104), the backlight control unit 130 determines the backlight luminance at the time of displaying the input image and at the time of displaying the interpolation image, based on the luminance ratio (Step S120).

The backlight control unit 130 outputs a luminance signal in accordance with the determined backlight luminance (Step S122). Further, the output unit 110 outputs the input image and the interpolation image (Step S124). The timing at which the input image is output by the output unit 110 is controlled in such a manner that the input image is irradiated by the backlight 30 in accordance with the luminance signal from the backlight control unit 130. The image display apparatus 4 thus completes the image display process.

Accordingly, even if the luminance ratios of the input image and interpolation image are not converted, the same effect can be accomplished as the case of converting the luminance ratios of the input image and interpolation image, by controlling the luminance ratio of the backlight 30. That is, the image quality can be improved by adding the interpolation image. Further, when the accuracy of the interpolation image is low, the image quality can be improved by decreasing the luminance.

Any other configuration and processing of the image display apparatus 4 according to Embodiment 4 are the same as those of the image display apparatuses of other embodiments.

According to a modification of Embodiment 4, the luminance ratio determining unit 106 may determine the luminance ratio based on the previous luminance ratio and the target luminance ratio, like the image display apparatus 2 according to Embodiment 2. In this case, the backlight control unit 130 controls the backlight based on the previous luminance ratio and the target luminance ratio.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus to display images, comprising:
an interpolation image generating unit that generates an interpolation image between frames of an input image, from the input image;
an evaluating unit that evaluates image accuracy of the interpolation image;
a luminance ratio setting unit that sets luminance ratios of the input image and the interpolation image in such a manner that luminance of the interpolation image decreases as the image accuracy decreases;
a luminance converting unit that generates a converted input image and a converted interpolation image by converting luminance of the input image and the luminance of the interpolation image respectively in accordance with the luminance ratio; and
a display unit that displays one of the converted input image and the converted interpolation image in a first half of one frame period of the input image, and displaying other image thereof in a second half.

2. The apparatus according to claim 1, wherein
the display unit includes
a liquid crystal panel,
a surface light source which is arranged at back of the liquid crystal panel and serves as lighting of the liquid crystal panel, and
a surface light source control unit that controls the surface light source in such a manner that an amount of light of the surface light source decreases as the luminance ratio of the interpolation image increases.

3. The apparatus according to claim 1, further comprising:
a current luminance ratio acquiring unit that acquires a current luminance ratio which is a luminance ratio of a current interpolation image;
a target luminance ratio calculating unit that calculates a target luminance ratio which is a target luminance ratio of a next interpolation image in such a manner that luminance of the next interpolation image decreases as the image accuracy decreases, based on the image accuracy of the next interpolation image; and
a difference calculating unit that calculates a difference between the target luminance ratio and the current luminance ratio, wherein
the luminance ratio setting unit changes the luminance ratio of the next interpolation image by a variation amount which is a smaller of the difference and an upper limit of a predetermined variation range.

4. An apparatus comprising:
an interpolation image generating unit that generates an interpolation image between frames of an input image, from the input image;
an evaluating unit that evaluates image accuracy of the interpolation image;
a luminance ratio setting unit that sets luminance ratios of the input image and the interpolation image, in such a manner that the interpolation image becomes darker as the image accuracy decreases;
an output unit that outputs the input image and the interpolation image on a liquid crystal panel in one frame period;
a surface light source that is arranged at back of the liquid crystal panel and serves as lighting of the liquid crystal panel; and
a surface light source control unit that controls output of the surface light source, in accordance with the luminance ratio set by the luminance ratio setting unit.

5. The apparatus according to claim 4, further comprising
a current luminance ratio acquiring unit that acquires a current luminance ratio which is a luminance ratio of a current interpolation image,
a target luminance ratio calculating unit that calculates a target luminance ratio which is a target luminance ratio of a next interpolation image, in such a manner that the next interpolation image becomes darker as the image accuracy decreases, and
a difference calculating unit that calculates a difference between the target luminance ratio and the current luminance ratio, wherein
the luminance ratio setting unit changes the luminance ratio of the next interpolation image by a variation amount which is a smaller of the difference and an upper limit of a predetermined variation range.

6. The apparatus according to claim 1, wherein
the evaluating unit evaluates the image accuracy based on a motion estimation residual of the input image used for generating the interpolation image.

7. The apparatus according to claim 1, wherein
the evaluating unit evaluates the image accuracy based on a motion compensation estimation residual in a predetermined area of the input image used for generating the interpolation image.

8. The apparatus according to claim 1, wherein
the evaluating unit evaluates the image accuracy based on a number of images whose motion estimation residuals are equal to or greater than a predetermined threshold value, within the input image used for generating the interpolation image.

9. The apparatus according to claim 1, wherein
the evaluating unit evaluates the image accuracy, based on a number of pixels whose motion compensation estimation residuals are equal to or greater than a predetermined threshold value within a predetermined area of the input image used for generating the interpolation image.

10. An image display method comprising:
generating an interpolation image between frames of an input image, from the input image;
evaluating image accuracy of the interpolation image;
setting luminance ratios of the input image and the interpolation image in such a manner that luminance of the interpolation image decreases as the image accuracy decreases;
generating a converted input image and a converted interpolation image by converting luminance of the input image and the luminance of the interpolation image respectively, in accordance with the luminance ratio; and
displaying one of the converted input image and the converted interpolation image in a first half of one frame period of the input image, and displaying other image thereof in a second half.

11. The method according to claim 10, further comprising controlling a surface light source, which is arranged at back of a liquid crystal panel and serves as lighting of the liquid crystal panel, in such a manner that an amount of light of the surface light source decreases.

12. The method according to claim 10, further comprising
obtaining a current luminance ratio which is a luminance ratio of a current interpolation image;
calculating a target luminance ratio which is a target luminance ratio of a next interpolation image in such a manner that luminance of the next interpolation image decreases as the image accuracy decreases, based on the image accuracy of the next interpolation image;
calculating a difference between the target luminance ratio and the current luminance ratio; and
changing the luminance ratio of the next interpolation image by a variation amount which is a smaller of the difference and an upper limit of a predetermined variation range.

13. An image display method comprising:
generating an interpolation image between frames of an input image, from the input-image;
determining image accuracy of the interpolation image;
setting luminance ratios of the input image and the interpolation image in such a manner that the interpolation image becomes darker as the image accuracy decreases, based on the image accuracy;
outputting the input image and the interpolation image on a liquid crystal panel for one frame period; and
controlling output of a surface light source which is arranged at back of the liquid crystal panel and serves as lighting of the liquid crystal panel, in accordance with the set luminance ratios.

14. The method according to claim 13, further comprising
specifying a previous luminance ratio of a previous interpolation image which is output immediately before the interpolation image output in the outputting;
calculating a target luminance ratio of the interpolation image in such a manner that the interpolation image becomes darker as the image accuracy decreases, based on the image accuracy;
calculating a difference between the target luminance ratio and the previous luminance ratio; and
changing the luminance ratio of the next interpolation image by a variation amount which is a smaller of the difference and an upper limit of a predetermined variation range.

15. A computer program product having a computer readable medium including programmed instructions, wherein the instructions, when executed by a computer, cause the computer to perform:
generating an interpolation image between frames of an input image, from the input image;
evaluating image accuracy of the interpolation image;
setting luminance ratios of the input image and the interpolation image in such a manner that luminance of the interpolation image decreases as the image accuracy decreases;
generating a converted input image and a converted interpolation image by converting luminance of the input image and the luminance of the interpolation image respectively in accordance with the luminance ratio; and
displaying one of the converted input image and the converted interpolation image in a first half of one frame period of the input image, and displaying other image thereof in a second half.

16. The computer program product according to claim 15, wherein the instructions, when executed by a computer, cause the computer to further perform:
controlling a surface light source, which is arranged at back of a liquid crystal panel and serves as lighting of the liquid crystal panel, in such a manner that an amount of light of the surface light source decreases.

17. The computer program product according to claim 15, wherein the instructions, when executed by a computer, cause the computer to further perform:
obtaining a current luminance ratio which is a luminance ratio of a current interpolation image;
calculating a target luminance ratio which is a target luminance ratio of a next interpolation image in such a manner that luminance of the next interpolation image decreases as the image accuracy decreases, based on the image accuracy of the next interpolation image;
calculating a difference between the target luminance ratio and the current luminance ratio; and
changing the luminance ratio of the next interpolation image by a variation amount which is a smaller of the difference and an upper limit of a predetermined variation range.

18. A computer program product having a computer readable medium including programmed instructions, wherein the instructions, when executed by a computer, cause the computer to perform:
generating an interpolation image between frames of an input image, from the input image;
determining image accuracy of the interpolation image;
setting luminance ratios of the input image and the interpolation image in such a manner that the interpolation image becomes darker as the image accuracy decreases, based on the image accuracy;
outputting the input image and the interpolation image on a liquid crystal panel for one frame period; and
controlling output of a surface light source which is arranged at back of the liquid crystal panel and serves as lighting of the liquid crystal panel, in accordance with the set luminance ratios.

19. The computer program product according to claim 18, wherein the instructions, when executed by a computer, cause the computer to further perform:
specifying a previous luminance ratio of a previous interpolation image which is output immediately before the interpolation image output in the outputting;
calculating a target luminance ratio of the interpolation image in such a manner that the interpolation image becomes darker as the image accuracy decreases, based on the image accuracy;
calculating a difference between the target luminance ratio and the previous luminance ratio; and
changing the luminance ratio of the next interpolation image by a variation amount which is a smaller of the difference and an upper limit of a predetermined variation range.
